(19) United States
(12) Patent Application Publication
(10) Pub. No.: US 2026/0117919 A1
(43) Pub. Date: Apr. 30, 2026

(54) ELECTRIC STAND AND MONITOR APPARATUS THEREOF

(71) Applicant: BENQ CORPORATION, Taipei City (TW)

(72) Inventors: Shih-Ho Chen, Taipei City (TW); Lin-Yuan You, Taipei City (TW); Ho-Tsung Hsueh, Taipei City (TW); Liu-Yi Huang, Taipei City (TW); Meng-Yang Hsiao, Taipei City (TW); Jen-Hsiang Chan, Taipei City (TW)

(73) Assignee: BENQ CORPORATION, Taipei City (TW)

(21) Appl. No.: 19/315,639

(22) Filed: Aug. 31, 2025

(30) Foreign Application Priority Data
Oct. 30, 2024 (TW) 113141423

(51) Int. Cl. F16M 11/24; F16M 11/12; F16M 11/20; F16M 13/02; G01L 5/00

(52) U.S. Cl. CPC F16M 11/24; F16M 11/125; F16M 11/2014; F16M 13/022; G01L 5/0061

(57) ABSTRACT

An electric stand includes a stand structure, a driving module disposed in the stand structure to drive the stand structure or a display monitor, and a strain sensor. The stand structure includes a support column, a rear cantilever pivoted to the support column, and a front cantilever pivoted to the rear cantilever and the display monitor. The strain sensor is coupled to the driving module and disposed on at least one of a position in the support column, a pivot position of the rear cantilever and the support column, a pivot position of the rear cantilever and the front cantilever, and a pivot position of the front cantilever and the display monitor. The strain sensor detects a stress variation exerted upon the stand structure or the display monitor and accordingly controls the driving module to drive the stand structure or the display monitor for moving the display monitor.

### BACKGROUND OF THE INVENTION

### 1. Field of the Invention

The present invention relates to an electric stand and a monitor apparatus thereof, and more specifically, to an electric stand moving a display monitor according to a stress variation exerted on the electric stand or the display monitor and detected by a strain sensor and a monitor apparatus thereof.

### 2. Description of the Prior Art

With the advancement of technology, a display monitor with an electric lifting function has been widely applied in daily life. A conventional electric lifting design involves placing a driving motor within a stand structure supporting the display monitor and utilizing a screw/gear linkage mechanism to raise or lower the stand structure. This allows a user to effortlessly adjust the display monitor to a suitable height for viewing or operation.

However, during the process of adjusting a height of the display monitor, it is common for the display monitor to collide with objects (e.g., items on a desk) or entangle with cables, which often causes damage to the display monitor or even injuries to the user. Moreover, the aforesaid design does not allow the user to adjust the height of the display monitor manually, which is not user-friendly, so as to cause much operational inconvenience in adjustment of the display monitor.

### SUMMARY OF THE INVENTION

Thus, one purpose of the present invention is to provide an electric stand moving a display monitor according to a stress variation exerted on the electric stand or the display monitor and detected by a strain sensor and a monitor apparatus thereof, to solve the aforesaid problems.

According to an embodiment, an electric stand of the present invention is suitable for connecting to a display monitor. The electric stand includes a stand structure, at least one driving member, and at least one strain sensor. The stand structure includes a support column, a rear cantilever, and a front cantilever. The rear cantilever is pivotally connected to the support column. The front cantilever is pivotally connected between the rear cantilever and the display monitor. The at least one driving module is disposed within the stand structure to drive the stand structure or the display monitor for moving the display monitor. The at least one strain sensor is electrically connected to the driving module and disposed on at least one of a first detection position located inside the support column, a second detection position where the rear cantilever is pivoted to the support column, a third detection position where the rear cantilever is pivoted to the front cantilever, and a fourth detection position where the front cantilever is pivoted to the display monitor. The strain sensor detects a stress variation exerted on the stand structure or the display monitor, and controls the driving module based on the stress variation to drive the stand structure or the display monitor for moving the display monitor.

According to another embodiment, a monitor apparatus of the present invention includes a display monitor and an electric stand connected to the display monitor. The electric stand includes a stand structure, at least one driving module, and at least one strain sensor. The stand structure includes a support column, a rear cantilever, and a front cantilever. The rear cantilever is pivotally connected to the support column. The front cantilever is pivotally connected between the rear cantilever and the display monitor. The at least one driving module is disposed within the stand structure to drive the stand structure or the display monitor for moving the display monitor. The at least one strain sensor is electrically connected to the driving module and disposed on at least one of a first detection position located inside the support column, a second detection position where the rear cantilever is pivoted to the support column, a third detection position where the rear cantilever is pivoted to the front cantilever, and a fourth detection position where the front cantilever is pivoted to the display monitor. The strain sensor detects a stress variation exerted on the stand structure or the display monitor, and controls the driving module based on the stress variation to drive the stand structure or the display monitor for moving the display monitor.

In summary, compared with the prior art adopting the design in which the electric stand only utilizes the motor to lift the display monitor without allowing the user to adjust the height of the display monitor manually, the present invention utilizes the strain sensor to detect the stress variation exerted on the stand structure or the display monitor and enable direct user adjustments. By simply pressing or lifting the display monitor, the user can intuitively move the display monitor to a suitable height for viewing or operation, which is user-friendly and greatly improves operational convenience of the electric stand.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a monitor apparatus according to an embodiment of the present invention.

FIG. 2 is a side view of the monitor apparatus in FIG. 1.

FIG. 3 is a side view of the monitor apparatus according to another embodiment of the present invention when the strain sensor is suspended above the driving module at a first detection position.

FIG. 4 is a side view of the monitor apparatus according to another embodiment of the present invention when the strain sensor is disposed at a second detection position.

FIG. 5 is a side view of a monitor apparatus according to another embodiment of the present invention when the strain sensor is disposed at a third detection position.

FIG. 6 is a side view of a monitor apparatus according to another embodiment of the present invention when the strain sensor is disposed at a fourth detection position.

FIG. 7 is a side view of a monitor apparatus according to another embodiment of the present invention when the strain sensor is disposed at the first detection position.

FIG. 8 is a side view of a monitor apparatus according to another embodiment of the present invention when the strain sensor is disposed at a fourth detection position.

FIG. 9 is a side view of a monitor apparatus according to another embodiment of the present invention when the strain sensor is disposed at the fourth detection position.

### DETAILED DESCRIPTION

The present invention will now be described more specifically with reference to the following embodiments and the accompanying drawings. Other advantages and effects of the present invention can be easily understood by a person ordinarily skilled in the art in view of the detailed descriptions and the accompanying drawings. The present invention can be implemented or applied to other different embodiments. Certain aspects of the present invention are not limited by the particular details of the examples illustrated herein. Without departing from the spirit and scope of the present invention, the present invention will have other modifications and changes. It should be understood that the appended drawings are not necessarily drawn to the scale and configuration of each component (e.g., the number and mounting positions of strain sensors and driving modules, and the driving mechanical design of the driving module) in the drawings is merely illustrative, not presenting an actual condition of the embodiments.

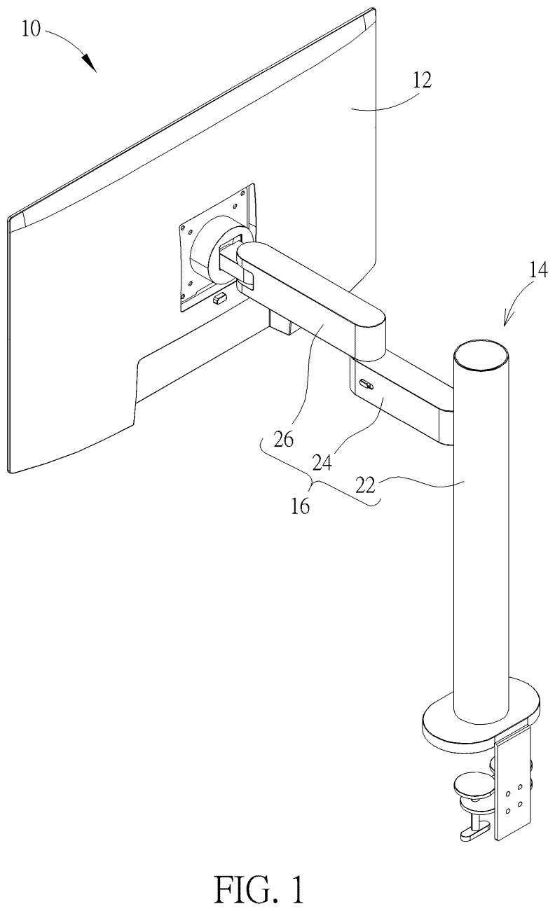

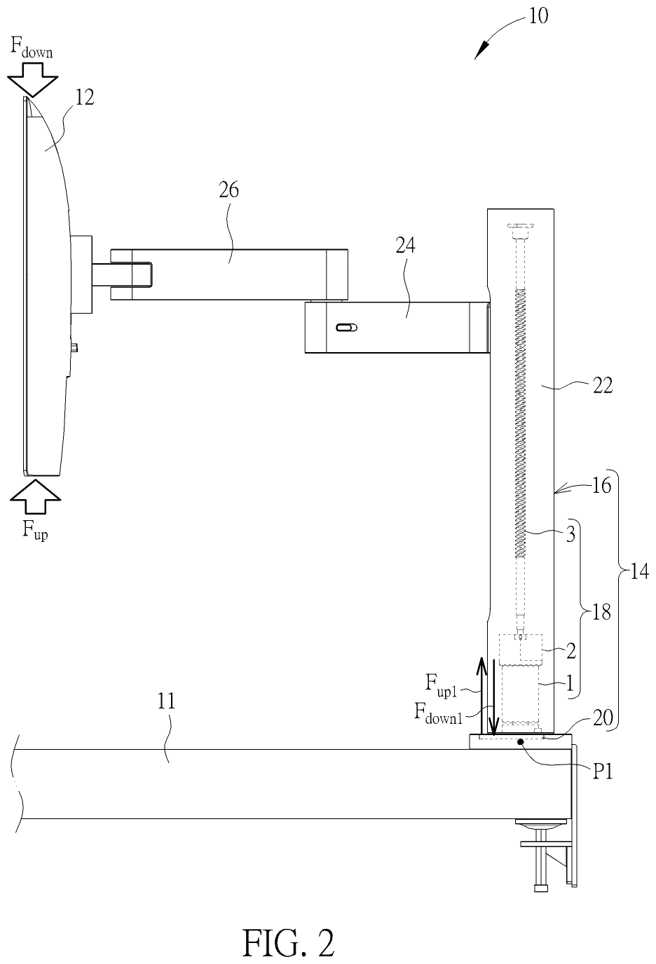

Please refer to FIG. 1 and FIG. 2. FIG. 1 is a diagram of a monitor apparatus 10 according to an embodiment of the present invention. FIG. 2 is a side view of the monitor apparatus 10 in FIG. 1. As shown in FIG. 1 and FIG. 2, the monitor apparatus 10 could be preferably a display device with a motorized stand adjustment function. The monitor apparatus 10 includes a display monitor 12 (e.g., an LCD screen, but not limited thereto) and an electric stand 14. The electric stand 14 includes a stand structure 16, a driving module 18, and a strain sensor 20 (implemented as a strain sensor using a strain gauge, such as a load cell, schematically indicated by dashed lines in FIG. 2).

The display monitor 12 could be preferably suspended above a plane (e.g., a support desktop 11) by being connected to a support column 22 vertically fixed on the plane. However, the present invention is not limited to the aforesaid upright support design. That is, the present invention could adopt other column connection design, such as securing the support column 22 to a ceiling to suspend the display monitor 12 below the ceiling or mounting the support column 22 on a vertical wall to hang the display monitor 12 laterally from the vertical wall, and the related description could be reasoned by analogy according to the following description and omitted herein.

As shown in FIG. 1 and FIG. 2, the stand structure 16 includes the support column 22, a rear cantilever 24, and a front cantilever 26. The rear cantilever 24 is pivotally connected between the support column 22 and the front cantilever 26, and the front cantilever 26 is pivotally connected to the display monitor 12 (e.g., via a VESA-standard mounting plate, wherein the related description is commonly seen in the prior art and omitted herein). The driving module 18 is disposed within the stand structure 16 to drive the stand structure 16 for adjusting the display monitor 12 (e.g., via a motorized gear mechanism as shown by dashed lines in FIG. 2, wherein the driving module 18 could include a motor 1, a gearbox 2 and a lead screw 3, but not limited thereto). The strain sensor 20 is electrically connected to the driving module 18 and disposed on at least one position where a stress variation exerted on the stand structure 16 or the display monitor 12 can be detected, such as a position inside the support column 22, a pivot position of the rear cantilever 24 and support column 22, a pivot position of the rear cantilever 24 and the front cantilever 26, and a pivot position of the front cantilever 26 and the display monitor 12. In such a manner, via the aforesaid pivotal connection design and the strain detection design in which the strain sensor 20 detects a stress variation received by the stand structure 16 or the display monitor 12, the strain sensor 20 controls the driving module 18 to drive the stand structure 16 or the display monitor 12 for moving the display monitor 12 at a desired viewing distance/angle for a user.

For example, as shown in FIG. 2, in an embodiment where the support column 22 is vertically adjustable on the support desktop 11 (e.g., fixed to the support desktop 11 in a tool clamping or screw locking manner, but not limited thereto), the strain sensor 20 is disposed at a first detection position P1 inside the support column 22, and the strain sensor 20 is a planar load cell pressed below the driving module 18, when the user applies a downward force F_{down} to lower the display monitor 12 (i.e., the display monitor 12 is pressed downward), the strain sensor 20 detects a downward component force F_{down1} transmitted through the rear cantilever 24 and the front cantilever 26 to the support column 22. According to this increased stress variation, the strain sensor 20 generates a driving signal to activate the motor 1 and then drive the support column 22 downward via the gearbox 2 and the lead screw 3, thereby lowering the display monitor 12 to a desired viewing or operating height. On the other hand, when an upward force Fᵤₚ is applied to raise the display monitor 12 (i.e., the display monitor 12 is lifted upward), the strain sensor 20 detects an upward component force Fᵤₚ₁ transmitted through the rear cantilever 24 and the front cantilever 26 to the support column 22. According to this reduced stress variation, the strain sensor 20 generates a driving signal to activate the motor 1 and then drive the support column 22 upward via the gearbox 2 and the lead screw 3, thereby raising the display monitor 12 to a desired viewing or operating height. To be noted, the aforesaid design is not limited to vertical column adjustment, meaning that the aforesaid design could also be applied to another embodiment where the driving module 18 drives the rear cantilever 24 and the front cantilever 26 for leftward-rightward/forward-backward movements, so as to enhance triaxial operational convenience and intuitiveness of the monitor apparatus 10. The related description could be reasoned by analogy according to the aforesaid embodiment and omitted herein.

Compared with the prior art adopting the electric stand design in which the electric stand only utilizes the motor to lift the display monitor without allowing the user to adjust the height of the display monitor manually, the present invention utilizes the strain sensor to detect the stress variation exerted on the stand structure or the display monitor and enable direct user adjustments. By simply pressing or lifting the display monitor, the user can intuitively move the display monitor to a suitable height for viewing improves or operation, which is user-friendly and greatly operational convenience of the electric stand.

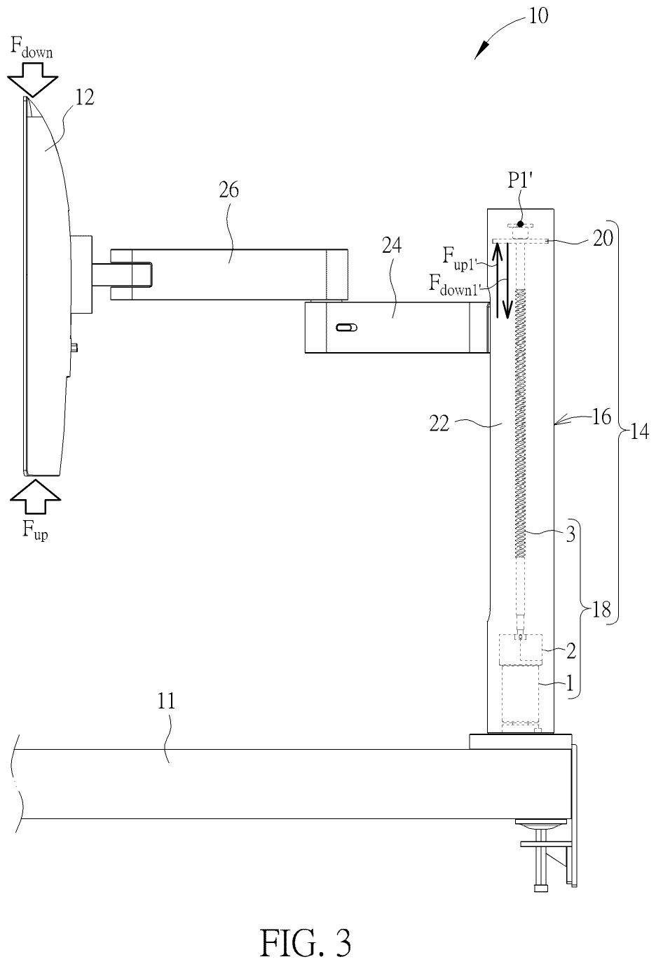

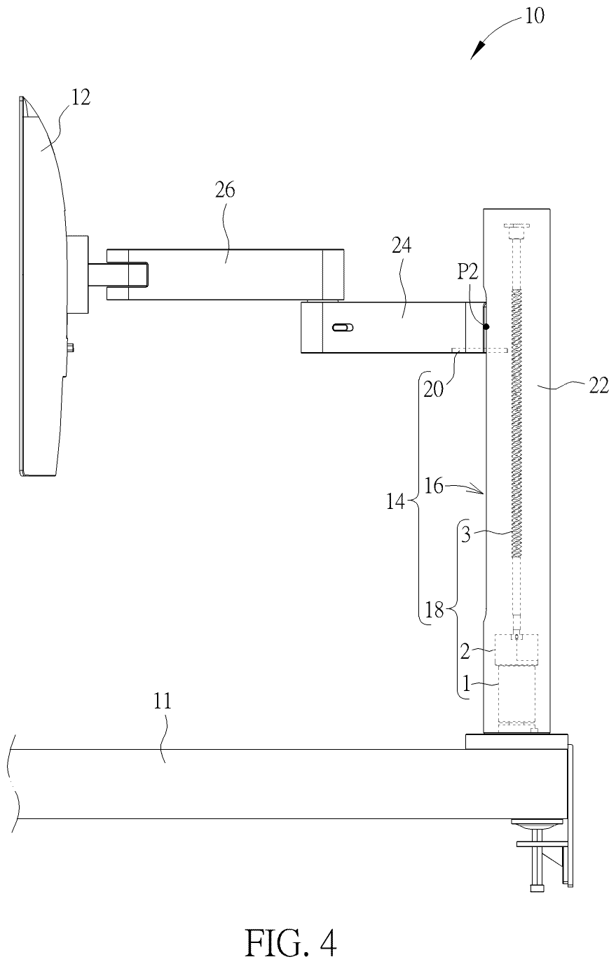

It should be mentioned that the mounting position of the strain sensor is not limited to the above embodiments. For example, please refer to FIG. 3, which is a side view of the monitor apparatus 10 according to another embodiment of the present invention when the strain sensor 20 is suspended above the driving module 18 at a first detection position P1′. Components both mentioned in this embodiment and the aforesaid embodiments represent components with similar structures or functions, and the related description is omitted herein. As shown in FIG. 3, in an embodiment where the support column 22 is vertically adjustable on the support desktop 11, the strain sensor 20 is disposed at the first detection position P1′ inside the support column 22, and the strain sensor 20 is a planar load cell suspended above the driving module 18, when the user wants to lower the display monitor 12 and directly applies the downward force F_{down} to press down the display monitor 12, the strain sensor 20 can detect a downward component force F_{down1′} and generate a driving signal based on the detected stress variation for controlling the driving module 18 to move the support column 22 downward. On the other hand, when the user wants to raise the display monitor 12 and directly applies the upward force Fᵤₚ to lift the display monitor 12, the strain sensor 20 can detect an upward component force F_{up1′} and generate a driving signal based on the detected stress variation for controlling the driving module 18 to move the support column 22 upward. In another embodiment, the strain sensor 20 could also be disposed at a second detection position P2 as shown in FIG. 4 and pressed below a pivot center between the rear cantilever 24 and the support column 22. The related description could be reasoned by analogy according to the aforesaid embodiment and omitted herein.

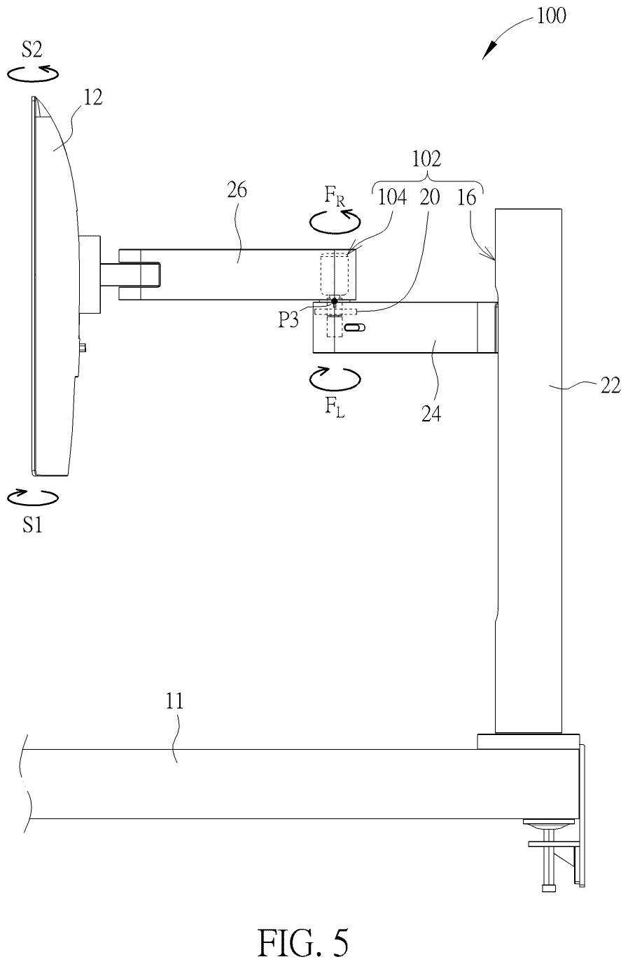

In addition, the present invention could also be applied to an embodiment where the display monitor is driven to swivel horizontally. For example, please refer to FIG. 5, which is a side view of a monitor apparatus 100 according to another embodiment of the present invention when the strain sensor 20 is disposed at a third detection position P3. Components both mentioned in this embodiment and the aforesaid embodiments represent components with similar structures or functions, and the related description is omitted herein. As shown in FIG. 5, the monitor apparatus 100 includes the display monitor 12 and an electric stand 102, and the electric stand 102 includes the stand structure 16, a driving module 104 (schematically shown by dashed lines in FIG. 5, which could adopt a driving mechanical design composed of a motor, a hinge and a gear set, but is not limited thereto), and the strain sensor 20. The display monitor 12 is pivotally connected to the front cantilever 26 to be swivelable horizontally relative to the support desktop 11. The strain sensor 20 is a torque-type load cell disposed at the third detection position P3 where the rear cantilever 24 is pivoted to the front cantilever 26 (e.g., connected to a horizontal pivot center between the front cantilever 26 and the rear cantilever 24). The driving module 104 is disposed at the pivot position between the rear cantilever 24 and the front cantilever 26. As such, when the user directly applies a force to swivel the display monitor 12 in a horizontal clockwise direction S1 or a horizontal counterclockwise direction S2, causing a force exerted on the display monitor 12 in a horizontal swiveling direction, the strain sensor 20 can detect a leftward swiveling force F_{L} or a rightward swiveling force F_{R} transmitted from the display monitor 12 through the front cantilever 26 to the rear cantilever 24. According to the detected stress variation, the strain sensor 20 generates a driving signal to control the driving module 104 to adjust a relative angle between the rear cantilever 24 and the front cantilever 26, thereby horizontally swiveling the display monitor 12 to a position suitable for viewing or operation.

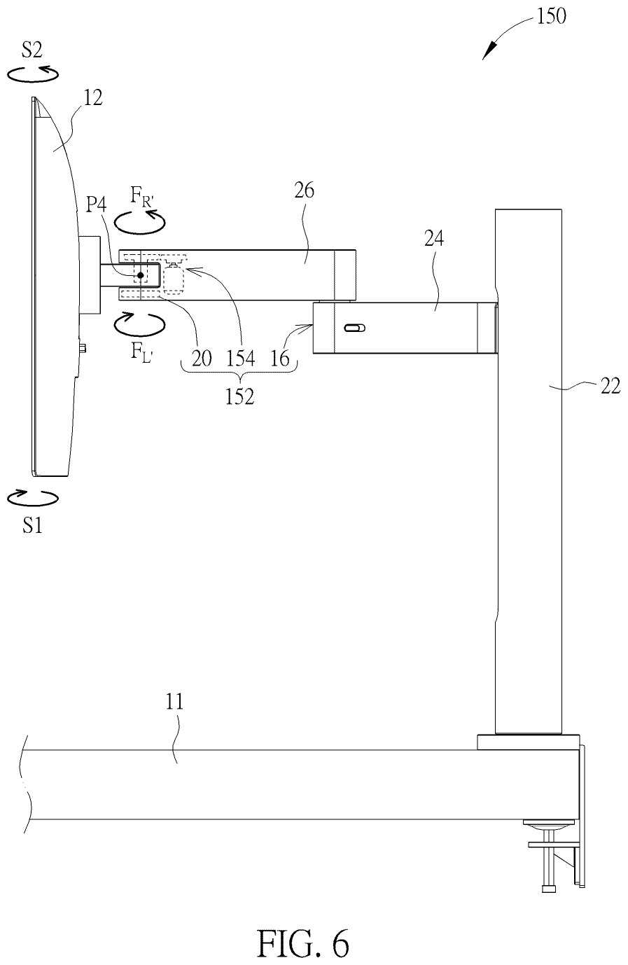

Alternatively, please refer to FIG. 6, which is a side view of a monitor apparatus 150 according to another embodiment of the present invention when the strain sensor 20 is disposed at a fourth detection position P4. Components both mentioned in this embodiment and the aforesaid embodiments represent components with similar structures or functions, and the related description is omitted herein. As shown in FIG. 6, the monitor apparatus 150 includes the display monitor 12 and an electric stand 152, and the electric stand 152 includes the stand structure 16, a driving module 154 (schematically shown by dashed lines in FIG. 6, which could adopt a drive mechanical design composed of a motor, a hinge and a gear set, but is not limited thereto), and the strain sensor 20. The display monitor 12 is pivotally connected to the front cantilever 26 to be swivelable horizontally relative to the support desktop 11. The strain sensor 20 is a torque-type load cell disposed at the fourth detection position P4 where the front cantilever 26 is pivoted to the display monitor 12 (e.g., connected to a horizontal pivot center between the front cantilever 26 and the display monitor 12). The driving module 154 is disposed in the front cantilever 26. As such, when the user directly applies a force to swivel the display monitor 12 in the horizontal clockwise direction S1 or the horizontal counterclockwise direction S2, causing a force exerted on the display monitor 12 in the horizontal swiveling direction, the strain sensor 20 can detect a leftward swiveling force F_{L′} or a rightward swiveling force F_{R′} transmitted from the display monitor 12 through the front cantilever 26 to the rear cantilever 24. According to the detected stress variation, the strain sensor 20 generates a driving signal to control the driving module 154 to adjust a relative horizontal angle between the display monitor 12 and the front cantilever 26, thereby horizontally swiveling the display monitor 12 to a position suitable for viewing or operation.

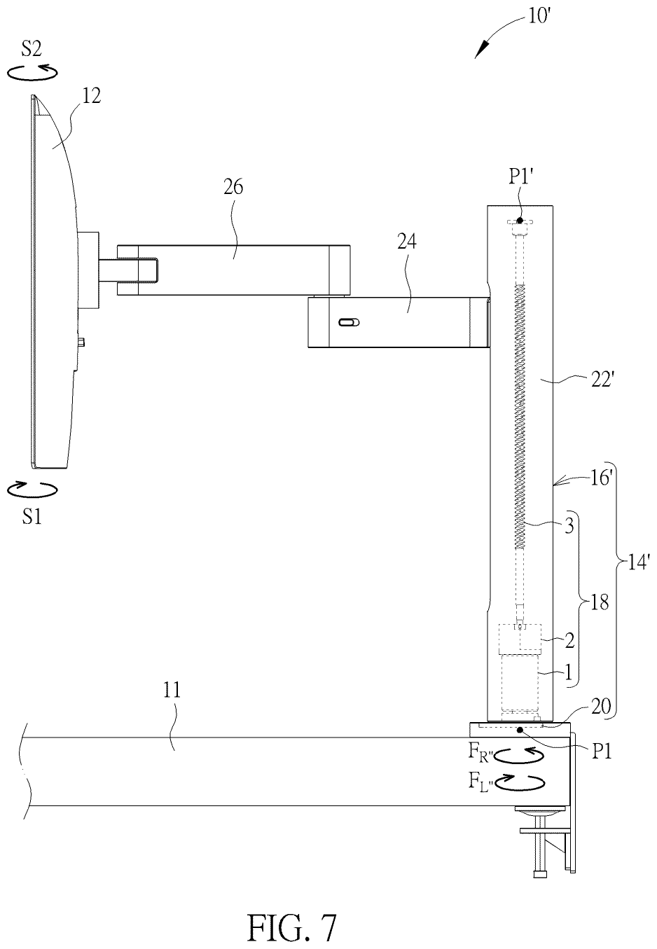

Alternatively, please refer to FIG. 7, which is a side view of a monitor apparatus 10′ according to another embodiment of the present invention when the strain sensor 20 is disposed at the first detection position P1. Components both mentioned in this embodiment and the aforesaid embodiments represent components with similar structures or functions, and the related description is omitted herein. As shown in FIG. 7, the monitor apparatus 10′ includes the display monitor 12 and an electric stand 14′, and the electric stand 14′ includes a stand structure 16′, the driving module 18 (schematically shown by dashed lines in FIG. 7, wherein the related description could be reasoned by analogy according to the aforesaid embodiments and omitted herein), and the strain sensor 20. The stand structure 16′ includes a support column 22′, the rear cantilever 24 and the front cantilever 26. The rear cantilever 24 is pivotally connected to the support column 22′ and the front cantilever 26. In this embodiment, the support column 22′ is pivotally disposed on the support desktop 11 to make the display monitor 12 swivelable horizontally relative to the support desktop 11. The strain sensor 20 is a torque-type load cell pressed below the driving module 18 at the first detection position P1 (or suspended above the driving module 18 at a first detection position P1′). The driving module 104 is disposed within the support column 22′. As such, when the user directly applies a force to swivel the display monitor 12 in the horizontal clockwise direction S1 or the horizontal counterclockwise direction S2, causing a force exerted on the display monitor 12 in the horizontal swiveling direction, the strain sensor 20 can detect a leftward swiveling force F_{L″} or a rightward swiveling force F_{R″} transmitted from the display monitor 12 through the front cantilever 26 and the rear cantilever 24 the support column 22′. According to the detected stress variation, the strain sensor 20 generates a driving signal to control the driving module 18 to rotate the support column 22′ horizontally (e.g., by a motorized lead-screw/gear linkage mechanism), thereby horizontally swiveling the display monitor 12 to a position suitable for viewing or operation.

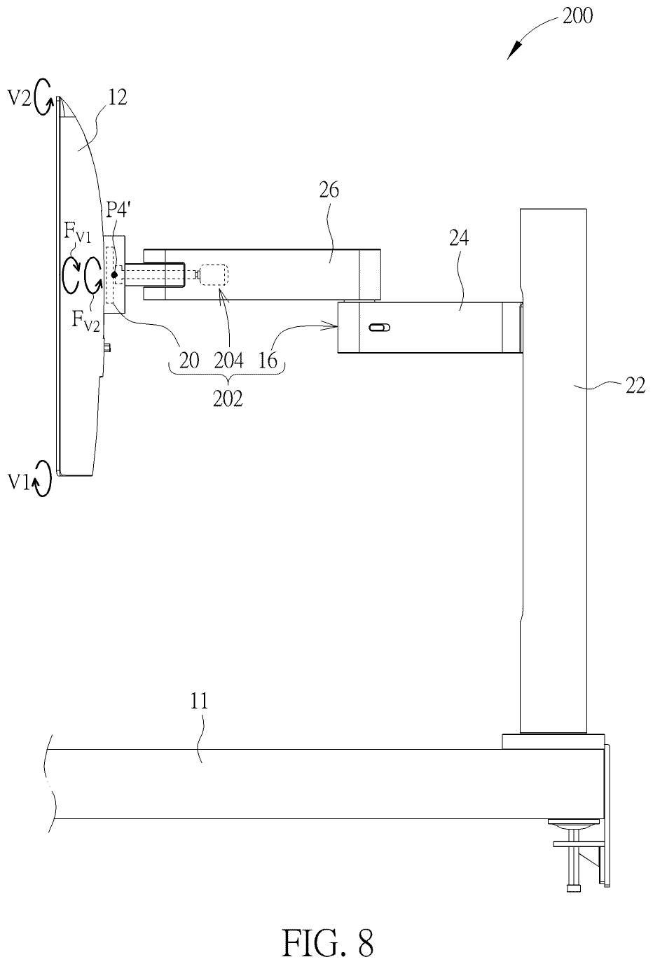

Furthermore, the present invention can also be applied to an embodiment where the display monitor is driven to pivot vertically. For example, please refer to FIG. 8, which is a side view of a monitor apparatus 200 according to another embodiment of the present invention when the strain sensor 20 is disposed at a fourth detection position P4′. Components both mentioned in this embodiment and the aforesaid embodiments represent components with similar structures or functions, and the related description is omitted herein. As shown in FIG. 8, the monitor apparatus 200 includes the display monitor 12 and an electric stand 202, and the electric stand 202 includes the stand structure 16, a driving module 204 (schematically shown by dashed lines in FIG. 8, which could adopt a drive mechanical design composed of a motor, a hinge and a gear set, but is not limited thereto), and the strain sensor 20. The display monitor 12 is pivotally connected to the front cantilever 26 to enable vertical clockwise or counterclockwise rotation relative to the support desktop 11. The strain sensor 20 is a torque-type (or planar) load cell disposed at the fourth detection position P4′ where the display monitor 12 is pivoted to the front cantilever 26 (e.g., connected to or pressed below a vertical pivot center between the front cantilever 26 and the display monitor 12). The driving module 204 is disposed at the pivot position between the display monitor 12 and the front cantilever 26. As such, when the user directly applies a force to pivot the display monitor 12 in a vertical clockwise direction V1 or a vertical counterclockwise direction V2, causing a force exerted on the display monitor 12 in a vertical pivot direction, the strain sensor 20 can detect a vertical clockwise force Fᵥ₁ or a vertical counterclockwise force Fᵥ₂ transmitted from the display monitor 12 to the front cantilever 26. According to the detected stress variation, the strain sensor 20 generates a driving signal to control the driving module 204 to adjust a relative vertical angle between the display monitor 12 and the front cantilever 26, thereby vertically pivoting the display monitor 12 to a position suitable for viewing or operation.

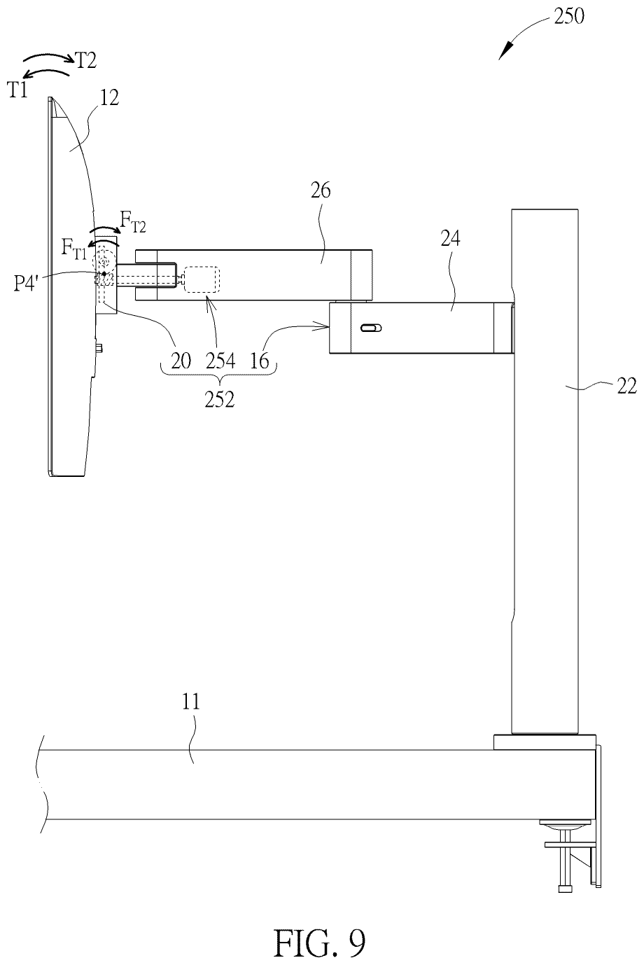

Moreover, the present invention can also be applied to an embodiment where the display monitor is driven to tilt vertically. For example, please refer to FIG. 9, which is a side view of a monitor apparatus 250 according to another embodiment of the present invention when the strain sensor 20 is disposed at the fourth detection position P4′. Components both mentioned in this embodiment and the aforesaid embodiments represent components with similar structures or functions, and the related description is omitted herein. As shown in FIG. 9, the monitor apparatus 250 includes the display monitor 12 and an electric stand 252, and the electric stand 252 includes the stand structure 16, a driving module 254 (schematically shown by dashed lines in FIG. 9, which could adopt a drive mechanical design composed of a motor, a worm screw and a gear set, but is not limited thereto), and the strain sensor 20. The display monitor 12 is pivotally connected to the front cantilever 26 to enable vertical clockwise or counterclockwise tilting relative to the support desktop 11. The strain sensor 20 is a planar (or torque-type) load cell disposed at the fourth detection position P4′ where the display monitor 12 is pivoted to the front cantilever 26 (e.g., connected to or pressed below a tilting center between the front cantilever 26 and the display monitor 12). The driving module 254 is disposed at the pivot position between the display monitor 12 and the front cantilever 26. As such, when the user directly applies a force to tilt the display monitor 12 in a forward direction T1 or a backward direction T2, causing a force exerted on the display monitor 12 in a vertical tilting direction, the strain sensor 20 can detect a forward tilting force F_{T1} or a backward tilting force F_{T2} transmitted from the display monitor 12 to the front cantilever 26. According to the detected stress variation, the strain sensor 20 generates a driving signal to control the driving module 254 to adjust a relative position between the display monitor 12 and the front cantilever 26, thereby tilting the display monitor 12 forward or backward to a position suitable for viewing or operation.

To be noted, the aforementioned embodiments involving force-driven vertical adjustment, vertical pivoting, horizontal swiveling, and forward/backward tilting of the display monitor can be implemented independently or selectively combined, and the number of driving modules and strain sensors could be adjusted accordingly to further enhance the design flexibility of the monitor apparatus. As for which design is adopted, it depends on the practical application of the monitor apparatus.

In practical applications, the monitor apparatus mentioned in the above embodiments could adopt a collision prevention design. For example, in the embodiment shown in FIG. 2, if an opposing force in a direction opposite to a moving direction of the display monitor 12 is exerted on the display monitor 12 (e.g., colliding with an object or entangling with a cable) during motorized adjustment by the driving module 18, the strain sensor 20 can detect the stress variation and immediately stop or reversely move the display monitor 12 to prevent further collision or damage, thereby improving operational safety of the monitor apparatus 10. Furthermore, the monitor apparatus could also adopt a tap detection design. For example, in the embodiment as shown in FIG. 2, when a force in a tapping direction is exerted on the stand structure 16 or the display monitor 12 by the user, the monitor apparatus 10 can control the driving module 18 to drive the stand structure 16 or the display monitor 12 for moving or stopping the display monitor 12 according to a detection frequency of the stress variation. For example, when the user wants to lift the display monitor 12, the user just needs to tap the display monitor 12 upward once (but not limited thereto), the strain sensor 20 can detect a stress variation applied to the stand structure 16 by the display monitor 12, and accordingly control the driving module 18 to drive the support column 22 to move upward, so as to raise the display monitor 12 to a height suitable for the user to view or operate. On the other hand, if the user wants to stop the display monitor 12, the user just needs to tap the display monitor 12 upward twice (but not limited thereto), so that the strain sensor 20 can detect the stress variation twice, and through the driving module 18, the display screen 12 is immediately stopped at a height desired by the user. As for related description for the collision prevent design and the tap detection design being applied to the other embodiments, it could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electric stand suitable for connecting to a display monitor, the electric stand comprising:
a stand structure comprising:
a support column;
a rear cantilever pivotally connected to the support column; and
a front cantilever pivotally connected between the rear cantilever and the display monitor;
at least one driving module disposed within the stand structure to drive the stand structure or the display monitor for moving the display monitor; and
at least one strain sensor electrically connected to the driving module and disposed on at least one of a first detection position located inside the support column, a second detection position where the rear cantilever is pivoted to the support column, a third detection position where the rear cantilever is pivoted to the front cantilever, and a fourth detection position where the front cantilever is pivoted to the display monitor;
wherein the strain sensor detects a stress variation exerted on the stand structure or the display monitor, and controls the driving module based on the stress variation to drive the stand structure or the display monitor for moving the display monitor.

2. The electric stand of claim 1, wherein the support column is vertically adjustable on a plane, and the strain sensor is disposed at the first detection position and is a planar load cell pressed below or suspended above the driving module; the strain sensor detects the stress variation when a downward force is exerted on the display monitor and controls the driving module to drive the support column downward for lowering the display monitor; the strain sensor detects the stress variation when an upward force is exerted on the display monitor and controls the driving module to drive the support column upward for raising the display monitor.

3. The electric stand of claim 1, wherein the support column is vertically adjustable on a plane, and the strain sensor is disposed at the second detection position and is a planar load cell pressed below a pivot center between the rear cantilever and the support column; the strain sensor detects the stress variation when a downward force is exerted on the display monitor, and controls the driving module to drive the support column downward for lowering the display monitor; the strain sensor detects the stress variation when an upward force is exerted on the display monitor, and controls the driving module to drive the support column upward for raising the display monitor.

4. The electric stand of claim 1, wherein the display monitor is pivotally connected to the front cantilever to be pivotable vertically relative to a plane, and the strain sensor is disposed at the fourth detection position and is a planar load cell or torque-type load cell connected to or pressed below a pivot center between the front cantilever and the display monitor; the strain sensor detects the stress variation when a force in a vertical pivoting direction is exerted on the display monitor, and controls the driving module to drive the stand structure or the display monitor for vertically pivoting the display monitor.

5. The electric stand of claim 1, wherein the display monitor is pivotally connected to the front cantilever to be swivelable horizontally relative to a plane, and the strain sensor is disposed at the fourth detection position and is a torque-type load cell connected to a pivot center between the front cantilever and the display monitor; the strain sensor detects the stress variation when a force in a horizontal swiveling direction is exerted on the display monitor, and controls the driving module to drive the stand structure or the display monitor for horizontally swiveling the display monitor.

6. The electric stand of claim 1, wherein the display monitor is pivotally connected to the front cantilever to be swivelable horizontally relative to a plane, and the strain sensor is disposed at the third detection position and is a torque-type load cell connected to a pivot center between the front cantilever and the rear cantilever; the strain sensor detects the stress variation when a force in a horizontal swiveling direction is exerted on the display monitor, and controls the driving module to drive the stand structure or the display monitor for horizontally swiveling the display monitor.

7. The electric stand of claim 1, wherein the support column is rotatably disposed on a plane, and the strain sensor is disposed at the first detection position and is a torque-type load cell pressed below or suspended above the driving module; the strain sensor detects the stress variation when a force in a horizontal swiveling direction is exerted on the display monitor, and controls the driving module to rotate the stand structure or the display monitor for horizontally swiveling the display monitor.

8. The electric stand of claim 1, wherein the display monitor is pivotally connected to the front cantilever to be tiltable vertically relative to a plane, and the strain sensor is disposed at the fourth detection position and is a planar load cell or torque-type load cell connected to or pressed below a pivot center between the front cantilever and the display monitor; the strain sensor detects the stress variation when a force in a vertical tilting direction is exerted on the display monitor, and controls the driving module to drive the stand structure or the display monitor for tilting the display monitor.

9. The electric stand of claim 1, wherein the strain sensor detects the stress variation when at least one force in a tapping direction is exerted on the stand structure or the display monitor, and controls the driving module to drive the stand structure or the display monitor for moving or stopping the display monitor according to a detection frequency of the stress variation.

10. The electric stand of claim 1, wherein the strain sensor detects the stress variation when an opposing force in a direction opposite to a moving direction of the display monitor is exerted on the display monitor, and controls the driving module to drive the stand structure or the display monitor for stopping or reversely moving the display monitor.

11. A monitor apparatus comprising:
a display monitor; and
an electric stand connected to the display monitor, the electric stand comprising:
a stand structure comprising:
a support column;
a rear cantilever pivotally connected to the support column; and
a front cantilever pivotally connected between the rear cantilever and the display monitor;
at least one driving module disposed within the stand structure to drive the stand structure or the display monitor for moving the display monitor; and
at least one strain sensor electrically connected to the driving module and disposed on at least one of a first detection position located inside the support column, a second detection position where the rear cantilever is pivoted to the support column, a third detection position where the rear cantilever is pivoted to the front cantilever, and a fourth detection position where the front cantilever is pivoted to the display monitor;
wherein the strain sensor detects a stress variation exerted on the stand structure or the display monitor, and controls the driving module based on the stress variation to drive the stand structure or the display monitor for moving the display monitor.

12. The monitor apparatus of claim 11, wherein the support column is vertically adjustable on a plane, and the strain sensor is disposed at the first detection position and is a planar load cell pressed below or suspended above the driving module; the strain sensor detects the stress variation when a downward force is exerted on the display monitor and controls the driving module to drive the support column downward for lowering the display monitor; the strain sensor detects the stress variation when an upward force is exerted on the display monitor and controls the driving module to drive the support column upward for raising the display monitor.

13. The monitor apparatus of claim 11, wherein the support column is vertically adjustable on a plane, and the strain sensor is disposed at the second detection position and is a planar load cell pressed below a pivot center between the rear cantilever and the support column; the strain sensor detects the stress variation when a downward force is exerted on the display monitor, and controls the driving module to drive the support column downward for lowering the display monitor; the strain sensor detects the stress variation when an upward force is exerted on the display monitor, and controls the driving module to drive the support column upward for raising the display monitor.

14. The monitor apparatus of claim 11, wherein the display monitor is pivotally connected to the front cantilever to be pivotable vertically relative to a plane, and the strain sensor is disposed at the fourth detection position and is a planar load cell or torque-type load cell connected to or pressed below a pivot center between the front cantilever and the display monitor; the strain sensor detects the stress variation when a force in a vertical pivoting direction is exerted on the display monitor, and controls the driving module to drive the stand structure or the display monitor for vertically pivoting the display monitor.

15. The monitor apparatus of claim 11, wherein the display monitor is pivotally connected to the front cantilever to be swivelable horizontally relative to a plane, and the strain sensor is disposed at the fourth detection position and is a torque-type load cell connected to a pivot center between the front cantilever and the display monitor; the strain sensor detects the stress variation when a force in a horizontal swiveling direction is exerted on the display monitor, and controls the driving module to drive the stand structure or the display monitor for horizontally swiveling the display monitor.

16. The monitor apparatus of claim 11, wherein the display monitor is pivotally connected to the front cantilever to be swivelable horizontally relative to a plane, and the strain sensor is disposed at the third detection position and is a torque-type load cell connected to a pivot center between the front cantilever and the rear cantilever; the strain sensor detects the stress variation when a force in a horizontal swiveling direction is exerted on the display monitor, and controls the driving module to drive the stand structure or the display monitor for horizontally swiveling the display monitor.

17. The monitor apparatus of claim 11, wherein the support column is rotatably disposed on a plane, and the strain sensor is disposed at the first detection position and is a torque-type load cell pressed below or suspended above the driving module; the strain sensor detects the stress variation when a force in a horizontal swiveling direction is exerted on the display monitor, and controls the driving module to rotate the stand structure or the display monitor for horizontally swiveling the display monitor.

18. The monitor apparatus of claim 11, wherein the display monitor is pivotally connected to the front cantilever to be tiltable vertically relative to a plane, and the strain sensor is disposed at the fourth detection position and is a planar load cell or torque-type load cell connected to or pressed below a pivot center between the front cantilever and the display monitor; the strain sensor detects the stress variation when a force in a vertical tilting direction is exerted on the display monitor, and controls the driving module to drive the stand structure or the display monitor for tilting the display monitor.

19. The monitor apparatus of claim 11, wherein the strain sensor detects the stress variation when at least one force in a tapping direction is exerted on the stand structure or the display monitor, and controls the driving module to drive the stand structure or the display monitor for moving or stopping the display monitor according to a detection frequency of the stress variation.

20. The monitor apparatus of claim 11, wherein the strain sensor detects the stress variation when an opposing force in a direction opposite to a moving direction of the display monitor is exerted on the display monitor, and controls the driving module to drive the stand structure or the display monitor for stopping or reversely moving the display monitor.
